(19) United States
(12) Patent Application Publication
(10) Pub. No.: US 2025/0155636 A1
(43) Pub. Date: May 15, 2025

(54) OPTICAL CIRCUIT BOARD

(71) Applicant: KYOCERA Corporation, Kyoto-shi, Kyoto (JP)

(72) Inventor: Akifumi SAGARA, Kyoto-shi (JP)

(73) Assignee: KYOCERA Corporation, Kyoto-shi, Kyoto (JP)

(21) Appl. No.: 18/832,153

(22) PCT Filed: Jan. 19, 2023
(86) PCT No.: PCT/JP2023/001463

§ 371 Date: Jul. 23, 2024

(30) Foreign Application Priority Data
Jan. 31, 2022 (JP) 2022-013040

(51) Int. Cl. G02B 6/12

(52) U.S. Cl. CPC G02B 6/12

(57) ABSTRACT

In the present disclosure, an optical circuit board includes a wiring board including an upper surface including a mounting region of an optical component, and an optical waveguide positioned at the wiring board. The optical waveguide is positioned adjacent to the mounting region, and includes a lower cladding, a core, and an upper cladding in this order from the upper surface side of the wiring board. The optical waveguide includes a first end surface facing the mounting region, and a second end surface including an end surface of the lower cladding, an end surface of the core, and an end surface of the upper cladding in the same plane and positioned on an opposite side to the first end surface. At the second end surface, at least a part of the end surfaces of the lower cladding and the upper cladding includes a protruding portion protruding relative to the end surface of the core.

### TECHNICAL FIELD

The present disclosure relates to an optical circuit board and an optical component mounting structure using the optical circuit board.

### BACKGROUND OF INVENTION

In recent years, optical fibers that allow high speed communication of enormous amounts of data have been used for telecommunications. Transmission and reception of optical signals are performed between an optical fiber and an optical component (silicon photonics device). The optical fiber and the optical component are connected through an optical waveguide as described in, for example, Patent Documents 1 and 2.

### CITATION LIST

### Patent Literature

Patent Document 1: JP 2001-330762 A
Patent Document 2: JP 4678155 B

### SUMMARY

### Solution to Problem

In the present disclosure, an optical circuit board includes a wiring board including an upper surface including a mounting region of an optical component, and an optical waveguide positioned at the wiring board. The optical waveguide is positioned adjacent to the mounting region, and includes a lower cladding, a core, and an upper cladding in this order from a side of the upper surface of the wiring board. The optical waveguide includes a first end surface facing the mounting region, and a second end surface including an end surface of the lower cladding, an end surface of the core, and an end surface of the upper cladding in the same plane, and the second end surface is positioned on an opposite side to the first end surface. At the second end surface, at least a part of the end surface of the lower cladding and the end surface of the upper cladding includes a protruding portion protruding relative to the end surface of the core.

In the present disclosure, an optical component mounting structure includes the optical circuit board described above, and an optical component positioned in the mounting region and including an optical transmission path. The end surface of the core at the first end surface and an end surface of the optical transmission path face each other.

### BRIEF DESCRIPTION OF THE DRAWINGS

FIG. 1 is a plan view illustrating an optical component mounting structure in which an optical component and an electronic component are mounted on an optical circuit board according to an embodiment of the present disclosure.

FIG. 2 is an enlarged explanatory view for describing a cross section of a region X illustrated in FIG. 1.

FIG. 3 is an enlarged explanatory view for describing an example of a cross section of a region Y illustrated in FIG. 2.

FIG. 4 is an enlarged explanatory view for describing another example of the cross section of the region Y illustrated in FIG. 2.

FIG. 5 is an enlarged explanatory view for describing an example in which a second end surface of an optical waveguide has a curved surface shape in the cross section of the region Y illustrated in FIG. 2.

FIG. 6 is an enlarged explanatory view for describing the fact that an electrical conductor layer has the largest thickness at the second end surface of the optical waveguide in the cross section of the region Y illustrated in FIG. 2.

### DESCRIPTION OF EMBODIMENTS

As described above, a known optical waveguide includes an end surface on a connector side to be connected to an optical fiber or the like. The end surface is easily damaged at the time of product inspection, transportation, or the like. In particular, when a core related to transmission of an optical signal is damaged, the transmission loss of an optical signal increases. Accordingly, an optical circuit board is required in which a possibility of damaging the end surface of the optical waveguide is reduced and the transmission loss of an optical signal is reduced.

In the present disclosure, as described above, in the optical circuit board, at least a part of the end surface of the lower cladding and the end surface of the upper cladding includes the protruding portion protruding relative to the end surface of the core at the second end surface. As a result, in the present disclosure, the optical circuit board can reduce the possibility of damaging the end surface of the optical waveguide and reduce the transmission loss of an optical signal.

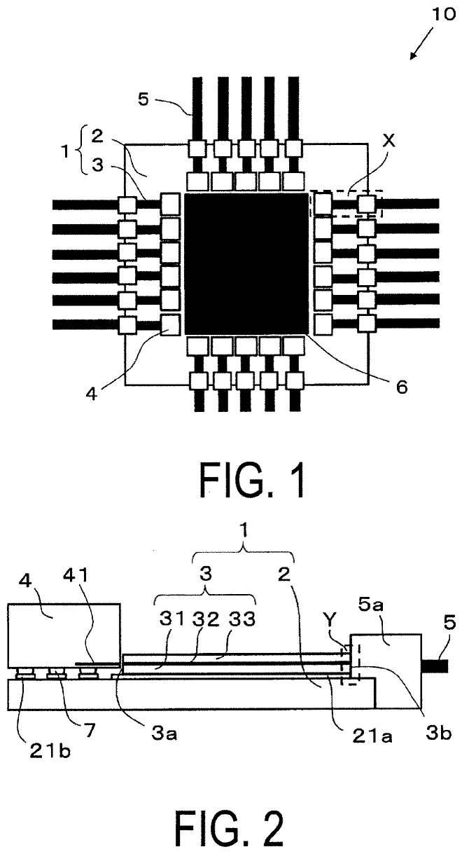

In an embodiment of the present disclosure, an optical circuit board will be described with reference to FIGS. 1 to 3. FIG. 1 is a plan view illustrating an optical component mounting structure 10 in which an optical component 4 is mounted on an optical circuit board 1 according to the embodiment of the present disclosure.

In the embodiment of the present disclosure, the optical circuit board 1 includes a wiring board 2 and an optical waveguide 3. Examples of the wiring board 2 included in the optical circuit board 1 according to the embodiment include a wiring board to be typically used for an optical circuit board.

Although not specifically illustrated, such a wiring board 2 includes, for example, a core substrate and build-up layers layered on both surfaces of the core substrate. The core substrate is not particularly limited as long as the core substrate is made of a material having an insulation property. Examples of the material having an insulation property include resins such as an epoxy resin, a bismaleimide-triazine resin, a polyimide resin, and a polyphenylene ether resin. Two or more types of these resins may be mixed and used. The core substrate usually includes a through hole conductor for electrically connecting the upper and lower surfaces of the core substrate.

The core substrate may contain a reinforcing material. Examples of the reinforcing material include insulation fabric materials such as glass fiber, glass non-woven fabric, aramid non-woven fabric, aramid fiber, and polyester fiber. Two or more types of reinforcing materials may be used in combination. An inorganic filler made of, for example, silica, barium sulfate, talc, clay, glass, calcium carbonate, or titanium oxide may be dispersed in the core substrate.

The build-up layer has a structure in which insulation layers and electrical conductor layers are alternately layered. A part of the electrical conductor layer positioned on the outermost surface (electrical conductor layer positioned on an upper surface of the wiring board 2) includes an electrical conductor layer 21a at which the optical waveguide 3 is positioned. The electrical conductor layer 21a is made of a metal such as copper, for example. The insulation layer included in the build-up layer is not limited to any particular material as long as the insulation layer has the same insulation property as and/or a similar insulation property to the core substrate. Examples of the material having the insulation property include resins such as an epoxy resin, a bismaleimide-triazine resin, a polyimide resin, and a polyphenylene ether resin. Two or more types of these resins may be mixed and used.

When two or more insulation layers are present in the build-up layer, the insulation layers may be made of the same resin or may be made of different resins. The insulation layer included in the build-up layer and the core substrate may be made of the same resin or may be made of different resins. The build-up layer usually includes a via hole conductor for electrically connecting the layers.

An inorganic filler made of, for example, silica, barium sulfate, talc, clay, glass, calcium carbonate, or titanium oxide may be dispersed in the insulation layer included in the build-up layer.

As illustrated in FIG. 2, the optical waveguide 3 included in the optical circuit board 1 according to the embodiment is positioned on a surface of the electrical conductor layer 21a. The electrical conductor layer 21a exists on the surface of the wiring board 2. FIG. 2 is an enlarged explanatory view for describing a cross section of a region X illustrated in FIG. 1. The optical waveguide 3 has a structure in which a lower cladding 31, an optical waveguide core 32, and an upper cladding 33 are layered in this order from a side of the electrical conductor layer 21a.

The lower cladding 31 included in the optical waveguide 3 is positioned on the surface of the wiring board 2, specifically, on the surface of the electrical conductor layer 21a. The electrical conductor layer 21a exists on a surface in an optical waveguide forming region of the wiring board 2. The material for forming the lower cladding 31 is not limited, and examples thereof include resins such as an epoxy resin and a silicone resin.

The upper cladding 33 included in the optical waveguide 3 is also made of resins such as an epoxy resin and a silicone resin, same as the lower cladding 31. The lower cladding 31 and the upper cladding 33 may be made of the same material or different materials. The lower cladding 31 and the upper cladding 33 may have the same thickness or different thicknesses. Each of the lower cladding 31 and the upper cladding 33 has a thickness of, for example, about 5 μm or more and 150 μm or less.

The optical waveguide core 32 included in the optical waveguide 3 is a portion through which light having entered the optical waveguide 3 propagates. Specifically, a side surface of an optical transmission path 41 included in the optical component 4 and a side surface of the optical waveguide core 32 of the optical waveguide 3 face each other. The optical component 4 is mounted in the mounting region of the wiring board 2. As illustrated in FIG. 2, a side surface of the optical waveguide 3 including the side surface of the optical waveguide core 32 facing the mounting region (optical component 4) of the wiring board 2 is referred to as a first end surface 3a.

At the first end surface 3a, optical signals are transmitted and received between the optical waveguide core 32 and the optical transmission path 41. The material for forming the optical waveguide core 32 is not limited, and is appropriately set in consideration of, for example, permeability of light and wavelength characteristics of propagating light. Examples of the material include resins such as an epoxy resin and a silicone resin. The optical waveguide core 32 has a thickness of, for example, about 3 μm or more and 50 μm or less.

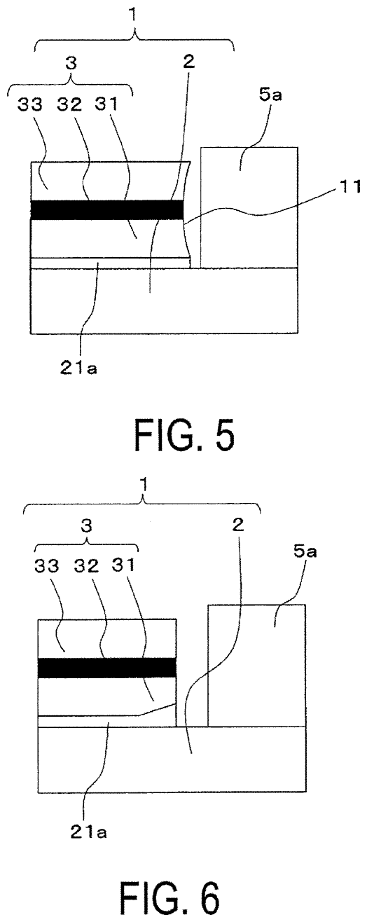

The optical waveguide 3 includes a second end surface 3b that is a side surface positioned on an opposite side to the first end surface 3a, and the second end surface 3b includes an end surface of the lower cladding 31, an end surface of the optical waveguide core 32, and an end surface of the upper cladding 33 in the same plane. To be specific, as illustrated in FIG. 2, in the optical waveguide 3, a side surface facing an optical connector 5a is the second end surface 3b. As illustrated in FIG. 5, the second end surface 3b may have a curved surface portion 11 including the end surface of the lower cladding 31, the end surface of the optical waveguide core 32, and the end surface of the upper cladding 33 in the same plane. The curved surface portion 11 refers to, for example, an arch shape in which the end surface of the lower cladding 31, the end surface of the optical waveguide core 32, and the end surface of the upper cladding 33 are continuously in contact with each other without an unevenness in a cross section thereof. At this time, an apex portion of the arch shape is positioned on an opposite side to the optical connector 5a. Including such a curved surface portion 11 is advantageous in that the possibility of damage to the end surface of the optical waveguide core 32 can be reduced.

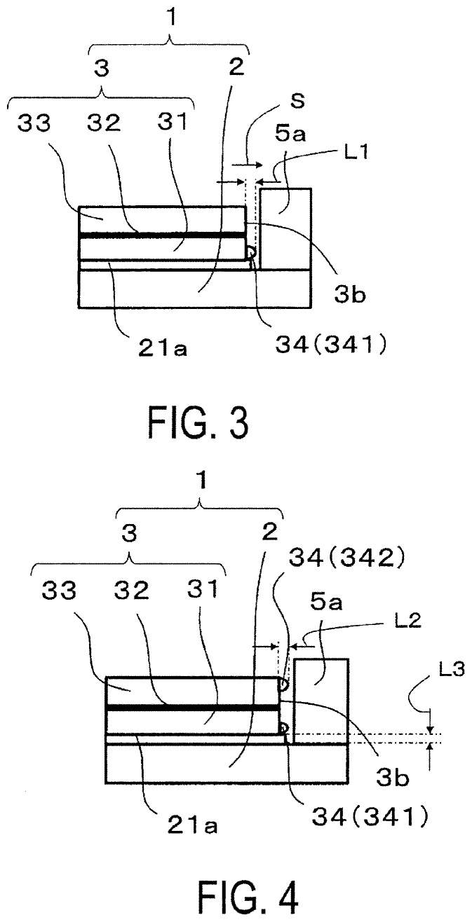

In the optical circuit board 1 according to the embodiment, as illustrated in FIG. 3, the second end surface 3b of the optical waveguide 3 includes a protruding portion 34 protruding relative to the end surface of the optical waveguide core 32 at a part of the end surface of the lower cladding 31. FIG. 3 is an enlarged explanatory view for describing an example of a cross section of a region Y illustrated in FIG. 2. Since the optical circuit board 1 according to the embodiment includes such a protruding portion 34, the possibility of damaging the end surface of the optical waveguide 3 (the second end surface 3b, in particular, the end surface of the optical waveguide core 32) can be reduced and the transmission loss of an optical signal can be reduced. As illustrated in FIG. 3, the protruding portion 34 positioned at the end surface of the lower cladding 31 may be referred to as a first protruding portion 341.

The protruding portion 34 (the first protruding portion 341) is made of, for example, the same material as that of the lower cladding 31 and may be formed integrally with the lower cladding 31. The first protruding portion 341 may be positioned below an intermediate part in a thickness direction of the lower cladding 31 (side closer to the wiring board 2) or may be positioned immediately above the electrical conductor layer 21a (lowermost part of the lower cladding 31). Since the first protruding portion 341 is located at such a position, the relatively strong electrical conductor layer 21a supports and reinforces the first protruding portion 341. When the first protruding portion 341 is positioned immediately above the electrical conductor layer 21a (the lowermost part of the lower cladding 31), the supporting effect by the electrical conductor layer 21a is further increased. By forming the first protruding portion 341 at a position away from the optical waveguide core 32, transmission of an optical signal is less likely to be interrupted, and the second end surface of the optical waveguide 3 (in particular, the end surface of the optical waveguide core 32) can be protected.

A length of the protruding portion 34, that is, a length L1 from the end surface of the optical waveguide core 32 to a front end of the protruding portion 34 may be, for example, 1 μm or more and 3.5 μm or less. In particular, when the protruding portion 34 is the first protruding portion 341, the length L1 may be, for example, 1.2 μm or more and 3.3 μm or less. When the protruding portion 34 (first protruding portion 341) has such a length, the second end surface of the optical waveguide 3 (in particular, the end surface of the optical waveguide core 32) can be sufficiently protected and the transmission efficiency of an optical signal can be sufficiently exhibited.

The end surface of the electrical conductor layer 21a (electrical conductor layer end surface) may be positioned immediately below the second end surface 3b of the optical waveguide 3. For example, as illustrated in FIG. 3, the electrical conductor layer end surface may be positioned between the end surface of the optical waveguide core 32 and the front end of the protruding portion 34 in a direction S in which the protruding portion 34 protrudes as illustrated in FIG. 3. These may be appropriately set in consideration of connectivity with the optical connector 5a. When a plurality of protruding portions 34 are present, the “front end of the protruding portion 34” means a front end of a protruding portion 34 whose distance from the end surface of the optical waveguide core 32 to the front end of the protruding portion 34 is the longest.

When the electrical conductor layer end surface is positioned between the end surface of the optical waveguide core 32 and the front end of the protruding portion 34 in the direction S in which the protruding portion 34 protrudes, the lower cladding 31 being relatively soft can absorb an impact, and the electrical conductor layer 21a being relatively strong can protect the optical waveguide 3 from the impact. As illustrated in FIG. 4, a thickness L3 of the electrical conductor layer 21a may be the largest at the electrical conductor layer end surface. A length from the end surface of the optical waveguide core 32 to the electrical conductor layer end surface may be, for example, 0.7 μm or more and 2 μm or less.

As illustrated in FIG. 3, the protruding portion 34 need not be positioned only at the end surface of the lower cladding 31, but may be positioned only at the end surface of the upper cladding 33, or may be positioned at both of the end surface of the lower cladding 31 and the end surface of the upper cladding 33, as illustrated in FIG. 4. FIG. 4 is an enlarged explanatory view for describing another example of the cross section of the region Y illustrated in FIG. 2. As illustrated in FIG. 4, the protruding portion 34 positioned at the end surface of the upper cladding 33 is referred to as a second protruding portion 342.

The second protruding portion 342 may be preferably positioned at an upper part of the end surface of the upper cladding 33. For example, the second protruding portion 342 may be positioned continuously to an upper surface of the upper cladding 33. The expression that “the second protruding portion is positioned continuously to the upper surface of the upper cladding” means that an upper part of a root of the second protruding portion 342 is substantially flush with the upper surface of the upper cladding 33. By forming the second protruding portion 342 at a position away from the optical waveguide core 32, transmission of an optical signal is less likely to be interrupted, and the second end surface of the optical waveguide 3 (in particular, the end surface of the optical waveguide core 32) can be protected. The protruding portion 34 (the second protruding portion 342) is made of, for example, the same material as that of the upper cladding 33, and may be formed integrally with the upper cladding 33.

When the protruding portion 34 is the second protruding portion 342, a length L2 from the end surface of the optical waveguide core 32 to the front end of the second protruding portion 342 may be, for example, 1 μm or more and 3.5 μm or less. When the second protruding portion 342 has such a length, the second end surface of the optical waveguide 3 (in particular, the end surface of the optical waveguide core 32) can be sufficiently protected, and the transmission efficiency of an optical signal can be sufficiently exhibited.

As illustrated in FIG. 4, when each of the protruding portions 34 is positioned respectively at both of the lower cladding 31 and the upper cladding 33, the length L2 of the second protruding portion 342 (the length from the end surface of the optical waveguide core 32 to the end surface of the second protruding portion 342) may be longer than the length L1 of the first protruding portion 341 (the length from the end surface of the optical waveguide core 32 to the front end of the second protruding portion 342). With such a configuration, the possibility of damaging the end surface of the optical waveguide 3 can be further reduced.

Although not illustrated, a solder resist may be partially located on the surface of the wiring board 2. The solder resist is made of resins, and examples of the resins include an acryl-modified epoxy resin.

The end surface (board end surface) of the wiring board 2 may be positioned between the second end surface 3b of the optical waveguide core 32 and the front end of the protruding portion 34 in the direction in which the protruding portion 34 protrudes. When a plurality of protruding portions 34 are present, the “front end of the protruding portion 34” means the front end of the protruding portion 34 whose distance from the end surface of the optical waveguide core 32 to the front end of the protruding portion 34 is the longest as described above.

An embodiment of a method of forming the protruding portion 34 at at least one selected from the group consisting of the lower cladding 31 and the upper cladding 33 at the second end surface 3b of the optical waveguide 3 will be described.

First, the wiring board 2 is prepared. The wiring board 2 includes, on its upper surface, a mounting region for the optical component 4 and an optical waveguide forming region that are adjacent to each other. The optical waveguide forming region of the wiring board 2 includes the electrical conductor layer 21a that is a part of the electrical conductor layer positioned on the outermost surface (the electrical conductor layer positioned on the upper surface of the wiring board 2). The mounting region of the wiring board 2 includes a pad 21b that is a part of the electrical conductor layer positioned on the outermost surface. The electrical conductor layer 21a and the pad 21b are made of metals such as copper.

Next, the lower cladding 31 is formed in the optical waveguide forming region. Specifically, a resin layer made of a resin such as an epoxy resin or a silicone resin is layered. The resin layer covers the optical waveguide forming region. Then, exposure and development are performed to form the lower cladding 31.

Next, the optical waveguide core 32 is formed along the upper surface of the lower cladding 31. The optical waveguide core 32 is formed into a predetermined shape by applying or attaching an epoxy resin, a silicone resin, or the like onto the lower cladding 31 as described above and then performing exposure and development processing.

Next, the upper cladding 33 is formed to cover the upper surface of the lower cladding 31 and the optical waveguide core 32. Like the lower cladding 31, the upper cladding 33 is also formed by performing exposure and development processing of a resin such as an epoxy resin or a silicone resin. The lower cladding 31 and the upper cladding 33 may be made of the same material or different materials. The lower cladding 31 and the upper cladding 33 may have the same thickness or different thicknesses.

Next, both of the end surfaces of the lower cladding 31, the optical waveguide core 32, and the upper cladding 33 are cut with, for example, a dicer to form the first end surface 3a and the second end surface 3b. In cutting with the dicer, compressive stress is applied to a position where the protruding portion 34 is formed. When the first protruding portion 341 is formed at the lower cladding 31, for example, the electrical conductor layer 21a may be rolled up with a dicing blade to apply compressive stress. When the second protruding portion 342 is formed at the upper cladding 33, for example, compressive stress may be applied in bringing the dicing blade into contact with the upper cladding 33.

Next, by performing heat treatment, the accumulated compressive stress is released, a part of at least one selected from the group consisting of the lower cladding 31 and the upper cladding 33 protrudes, and the protruding portion 34 (at least one selected from the group consisting of the first protruding portion 341 and the second protruding portion 341) is formed. The heat treatment temperature is performed, for example, at a temperature of 120° C. or higher and 160° C. or lower for a period of 30 minutes or longer and 60 minutes or shorter.

The optical component mounting structure of the present disclosure will be described. As illustrated in FIG. 1, the optical component mounting structure 10 according to an embodiment of the present disclosure has a structure in which the optical component 4 and an electronic component 6 are mounted on the optical circuit board 1 according to an embodiment. The optical component 4 mounted on the optical component mounting structure 10 according to the embodiment includes the optical transmission path 41. Examples of the optical component 4 including such an optical transmission path 41 include a silicon photonics device. Examples of the electronic component 6 include an application specific integrated circuit (ASIC) and a driver IC.

As illustrated in FIG. 2, the optical component 4 is electrically connected to the pad 21b positioned in the mounting region of the optical component 4 of the wiring board 2 with a solder 7 interposed therebetween. The pad 21b is a part of the electrical conductor layer positioned on the upper surface of the wiring board 2.

A silicon photonics device will be described as an example of the optical component 4. The silicon photonics device is, for example, a type of optical component including the optical transmission path 41 in which silicon (Si) is used as a core and silicon dioxide (SiO₂) is used as a cladding. The silicon photonics device includes a Si waveguide as the optical transmission path 41, and further includes a passivation film, a light source unit, a light detector, and the like, which are not illustrated. As described above, the optical transmission path 41 (Si waveguide 41) is positioned at one end portion of the optical waveguide 3 and faces the optical waveguide core 32 included in the optical waveguide 3.

For example, an electrical signal from the wiring board 2 is propagated to the light source unit included in the optical component 4 (silicon photonics device) via the solder 7. The light source unit is configured to emit light upon receiving the propagated electrical signal. The emitted optical signal is propagated to an optical fiber 5 connected via the optical connector 5a, through the optical transmission path 41 (Si waveguide 41) and the optical waveguide core 32.

In the optical component mounting structure 10 according to the embodiment, at least a part of the end surface of the lower cladding 31 and the end surface of the upper cladding 33 includes the protruding portion 34 protruding relative to the end surface of the optical waveguide core 32 at the second end surface 3b of the optical waveguide 3 included in the optical circuit board 1. This can reduce the possibility of damaging the second end surface 3b of the optical waveguide 3 (in particular, the end surface of the optical waveguide core 32). As a result, the optical component mounting structure 10 according to the embodiment can reduce the transmission loss of an optical signal.

### REFERENCE SIGNS

1 Optical circuit board
2 Wiring board
21a Electrical conductor layer
21b Pad
3 Optical waveguide
31 Lower cladding
32 Optical waveguide core
33 Upper cladding
34 Protruding portion
341 First protruding portion
342 Second protruding portion
4 Optical component
41 Optical transmission path (Silicon waveguide (Si waveguide))
5 Optical fiber
5a Optical connector
6 Electronic component
7 Solder
10 Optical component mounting structure
11 Curved surface portion
R1 Optical waveguide forming region
R2 Mounting region

1. An optical circuit board comprising:
a wiring board comprising an upper surface comprising a mounting region of an optical component; and
an optical waveguide positioned at the wiring board,
wherein the optical waveguide is positioned adjacent to the mounting region and comprises a lower cladding, a core, and an upper cladding in this order from a side of the upper surface of the wiring board,
the optical waveguide comprising a first end surface facing the mounting region, and a second end surface comprising an end surface of the lower cladding, an end surface of the core, and an end surface of the upper cladding in a same plane, the second end surface being positioned on an opposite side to the first end surface, and
at the second end surface, at least a part of the end surface of the lower cladding and the end surface of the upper cladding comprises a protruding portion protruding relative to the end surface of the core.

2. The optical circuit board according to claim 1,
wherein an electrical conductor layer is positioned on the upper surface of the wiring board, and
the optical waveguide is positioned on the electrical conductor layer.

3. The optical circuit board according to claim 2,
wherein the electrical conductor layer comprises an electrical conductor layer end surface positioned immediately below the second end surface, and
the electrical conductor layer end surface is positioned between the end surface of the core and a front end of the protruding portion in a direction in which the protruding portion protrudes.

4. The optical circuit board according to claim 2 or 3,
wherein the protruding portion comprises at least a first protruding portion positioned at the lower cladding, and
the first protruding portion is positioned immediately above the electrical conductor layer.

5. The optical circuit board according to any one of claims 1 to 4,
wherein the protruding portion comprises at least a second protruding portion positioned at the upper cladding, and
the second protruding portion is positioned continuously to an upper surface of the upper cladding.

6. The optical circuit board according to any one of claims 1 to 5,
wherein the wiring board comprises a board end surface positioned between the end surface of the core and a front end of the protruding portion in a direction in which the protruding portion protrudes.

7. The optical circuit board according to any one of claims 4 to 6,
wherein the first protruding portion protrudes relative to the end surface of the core at the second end surface by a length of 1.2 μm or more and 3.3 μm or less.

8. The optical circuit board according to any one of claims 5 to 7,
wherein the second protruding portion protrudes relative to the end surface of the core at the second end surface by a length of 1 μm or more and 3.5 μm or less.

9. The optical circuit board according to any one of claims 5 to 8,
wherein, in a direction in which the protruding portion protrudes, a length from the end surface of the core at the second end surface to a front end of the second protruding portion is longer than a length from the end surface of the core at the second end surface to a front end of the first protruding portion.

10. The optical circuit board according to any one of claims 1 to 9,
wherein the second end surface comprises a curved surface portion comprising the end surface of the lower cladding, the end surface of the core, and the end surface of the upper cladding in the same plane.

11. The optical circuit board according to any one of claims 2 to 10,
wherein the electrical conductor layer has a largest thickness at an end surface.

12. An optical component mounting structure comprising:
the optical circuit board according to any one of claims 1 to 11; and
an optical component positioned in the mounting region, the optical component comprising an optical transmission path;
wherein the end surface of the core at the first end surface and an end surface of the optical transmission path face each other.
